(19) United States
(12) Patent Application Publication
(10) Pub. No.: US 2012/0107773 A1
(43) Pub. Date: May 3, 2012

(54) Fiber Abutment Material and Structure of Dental Implant

(76) Inventors: Luke Lu, South Pasadena, CA (US); Toshihiro Tokizawa, Tokyo (JP); Ching Yuan Hwang, Taichung City (TW)

(21) Appl. No.: 12/912,979

(22) Filed: Oct. 27, 2010

(51) Int. Cl. A61C 8/00

(52) U.S. Cl. 433/173

(57) ABSTRACT

A fiber abutment material and structure of dental implant includes: a fiber resin abutment equipped with plural fiber center shafts, such as glass fiber center shaft, carbon fiber center shaft, quartz optical fiber center shaft, or glass fiber optics center shaft, in which the single, dual-layer or multi-layer fiber multiply enhances the intensity, and the fiber resin abutment with grind ability is easily modified on-site for the dentist, is equipped with considerable fibers with tensile strength higher than that of titanium or zirconia (ceramic), because of the fiber structure elasticity similar to natural tooth to be shock absorbed, to prevent the bone from hurting and decrease the damage to the base.

### BACKGROUND OF THE INVENTION

1. Field of Invention

The present invention relates to a technical field of implant products, more specifically to a fiber abutment material and structure of dental implant, in which the implant can be modified on-site, has greater tensile strength than that of titanium or zirconia, and has dentin elasticity similar to natural tooth. It will be shock absorbed when it hit, and it has less chance to be broken.

2. Description of the Related Art

As for the implant, which is the integrated application of medical treatment and technology, in clinical operation, a dental implant made of titanium alloy is implanted in the alveolar bone of a missing tooth, after a period of healing, a abutment is locked at the dental implant through a screw, then a denture made through bit mode is bonded to the peripheral surface of the abutment.

However, a bit mode of a patient is provided to a dental equipment manufacturer to fabricate a dental crown, after the dental crown is fabricated, the patient comes back to the hospital or clinic to fit the dental crown, because of the abutment made of metal or ceramic, if there is the problem of poor assembly inadequate edge, the doctor cannot repair immediately, and the dental crown is sent back to the dental equipment manufacturer to be repaired or rebuilt, the patient to and from the hospital or clinic causes inconvenience to the dentist and the patient.

Furthermore, tensile strength of the titanium or zirconia (ceramic) is not as good as that of the plural fiber resin abutment, the titanium or zirconia (ceramic) is difficult to modify on-site but sent back to the dental equipment manufacturer, and the titanium or zirconia (ceramic) is easily broken when hit.

### SUMMARY OF THE INVENTION

To resolve the technical problem: the conventional approach: a bit mode of a patient is provided to a dental equipment manufacturer to fabricate a dental crown, after the dental crown is fabricated, the patient comes back to the hospital or clinic to fit the dental crown, because of the abutment made of metal or ceramic, if there is the problem of poor assembly with inadequate edge, the doctor cannot repair immediately, and the dental crown is sent back to the dental equipment manufacturer to be repaired or rebuilt, the patient to and from the hospital or clinic causes inconvenience to the dentist and the patient. Furthermore, the intensity of the titanium or zirconia (ceramic) is not as good as that of the fiber resin abutment, the titanium or zirconia (ceramic) is difficult to modify on-site but sent back to the dental equipment manufacturer, and the zirconia (ceramic) is easily broken when hit, because of the poor flexibility, to damage the base.

The technical features for resolving problem: a fiber abutment material and structure of dental implant is provided, including a fiber resin abutment equipped with plural fibers center shafts, such as glass fiber center shaft, carbon fiber center shaft, quartz optical fiber center shaft, or glass fiber optics center shaft, in which the single, dual-layer or multi-layer fiber multiply enhances the strength, and the fiber resin abutment with grind ability is easily modified on-site for the dentist, is equipped with considerable fibers with higher tensile strength than that of titanium or zirconia (ceramic), and is difficultly broken when hit, because of the elasticity similar to natural tooth to be shock absorbed, to prevent the bone from hurting and decrease the damage to the base.

Referring to the effect of the prior art: the fiber abutment material and structure of dental implant of the present invention has well elasticity and tensile strength, and is easily processed on-site and preventing damaged, in which the tensile strength is higher than that of titanium or zirconia (ceramic), and the elasticity is similar to natural tooth to be shock absorbed, to prevent the bone from hurting and decrease the damage to the implant.

### BRIEF DESCRIPTION OF THE DRAWINGS

FIG. 1 is a three dimensional schematic view showing an embodiment of the present invention;

FIG. 2 is a three dimensional exploded view showing an embodying state of the present invention;

FIG. 3 is an integrated cross-section view showing an embodying state of the present invention;

FIG. 4 is a schematic view showing the round shape cross-section of dual-layer fiber as fiber optics structure;

FIG. 5 is a schematic view showing the hexagonal shape cross-section of dual-layer fiber; and

FIG. 6 is a schematic view showing the round shape cross-section of tri-layer fiber.

### DETAILED DESCRIPTION OF THE INVENTION

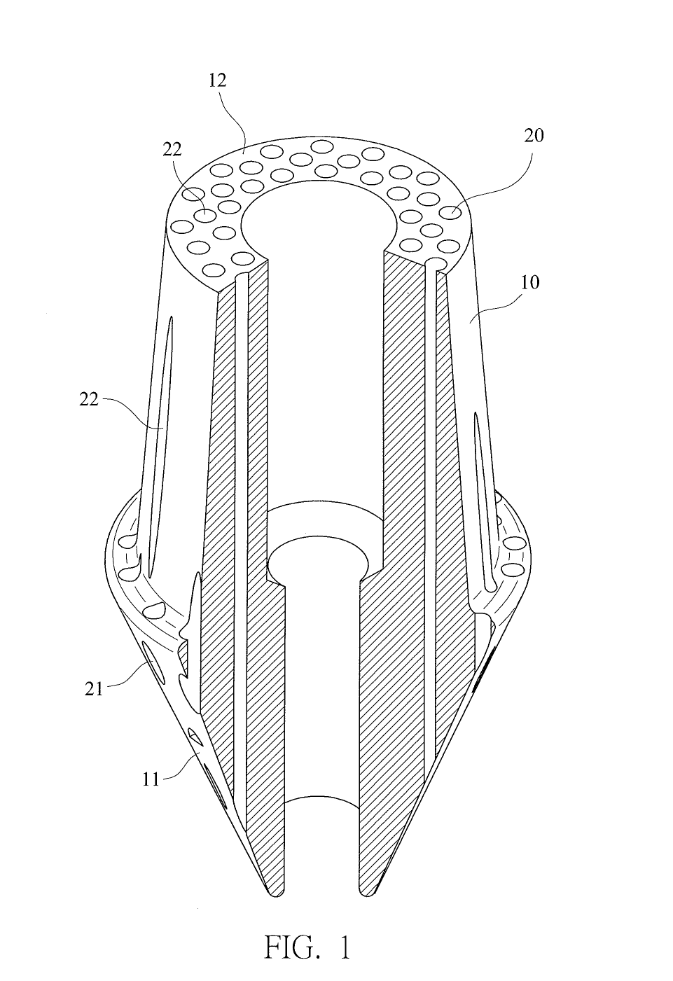

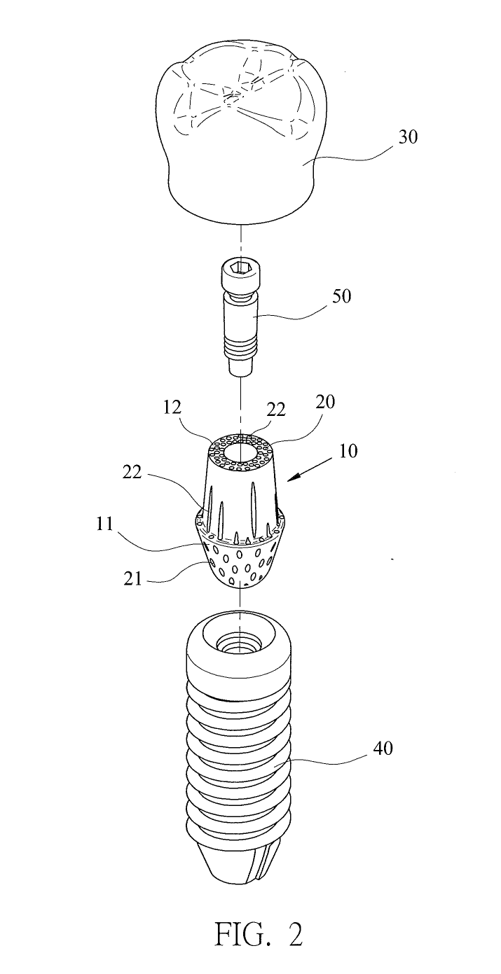

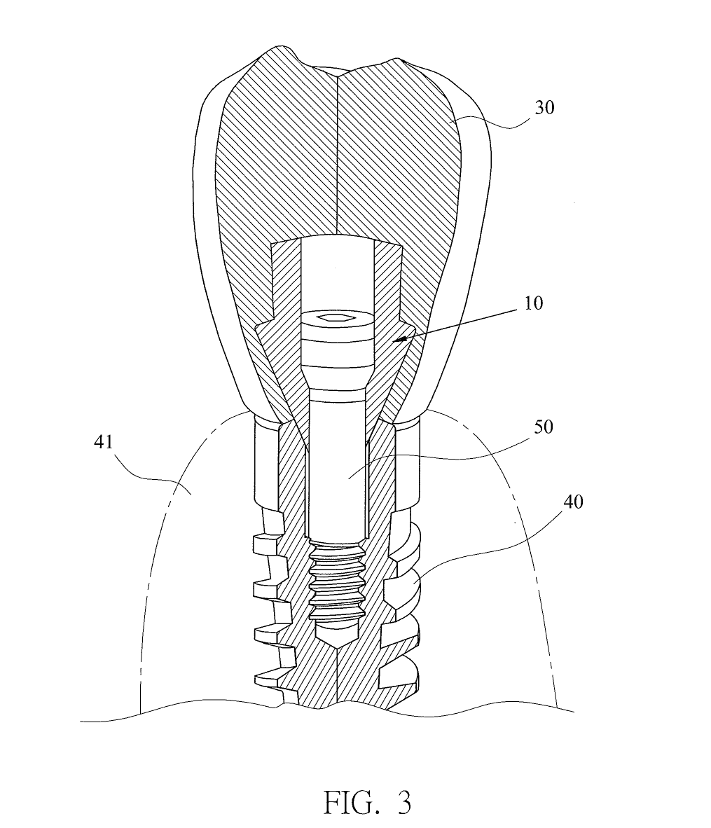

Referring to FIGS. 1-5, the present invention relates to a fiber abutment material and structure of dental implant, including:

a fiber resin abutment (10) installed with plural single fiber center shafts (20), such as glass fiber center shaft, quartz optical fiber center shaft, carbon fiber center shaft or glass fiber optics center shaft, in which the fiber resin abutment (10) is equipped with a peripheral junction (11), every fiber center shaft (20), which is passed and fixed in the fiber resin abutment (10), has a bottom combined end (21) and a top free end (22), each of the bottom combined ends (21) is placed at the peripheral junction (11) of the fiber resin abutment (10), each of the bottom combined ends (21) and the peripheral junction (11) are used for bonding a dental crown (30), and each of the top free ends (22) is placed at the position of a top surface (12) of the bonded dental crown (30) of the fiber resin abutment (10).

As for the implant steps, a titanium implant (40) is implanted in an alveolar bone (41), and the dental crown (30) is made through bit mode, after a period of healing, the fiber resin abutment (10) is locked at the titanium implant (40) through a screw (50), then the dental crown (30) is integrated with the peripheral junction(11) of the fiber resin abutment (10) through adhesive, during the integration, because of the well elasticity and tensile strength of the fiber resin abutment (10), the dental crown (30) is easily processed on-site, thus the integration process is faster and more convenient, the high strength of the structure of the dental crown (30) integrated with the titanium implant (40) is effectively improved, and the dental crown (30) is difficultly fall-off or damaged, which is very practical and convenient. Moreover, the fiber resin abutment (10) with grind ability is easily modified on-site for the dentist, and the fiber resin abutment (10) installed with considerable fiber center shafts (20) has the tensile strength higher than that of titanium or zirconia (ceramic) or stainless steel, wherein the intensity of the fiber center shaft (20) is greater than the tensile strength of titanium and the intensity of the titanium is greater than the tensile strength of zirconia (ceramic)and the intensity of the zirconia (ceramic) is greater than the tensile strength of stainless steel, and the fiber resin abutment (10) is difficultly broken when hit, because of the fiber structure similar elasticity to natural tooth to be shock absorbed, to prevent the bone from hurting and decrease the damage to the base of the titanium implant (40).

The glass fiber center shaft, quartz optical fiber center shaft, carbon fiber center shaft or glass fiber optics center shaft is single fiber, dual-layer fiber or multi-layer fiber, to multiply enhance the tensile strength intensity, that is, if the single fiber bear some pounds of impact force, the dual-layer fiber bear some tens pounds of impact force, and the multi-layer fiber bear some hundreds pounds of impact force.

the fiber resin abutment (10) is installed with plural single fiber center shafts (20).

the fiber center shaft (20) adopts the design of single fiber.

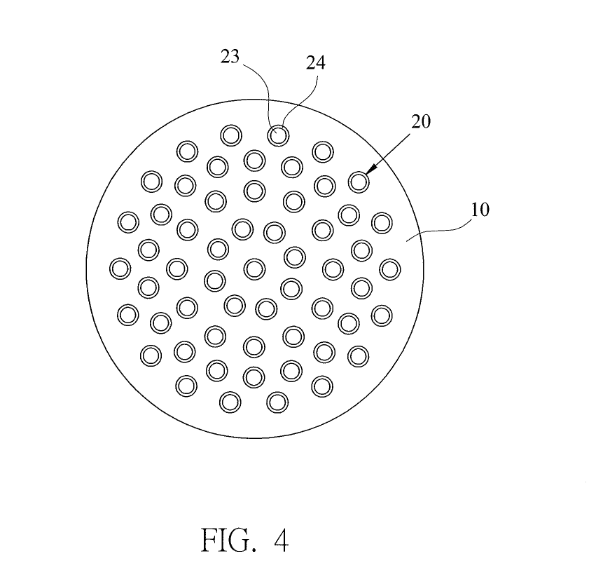

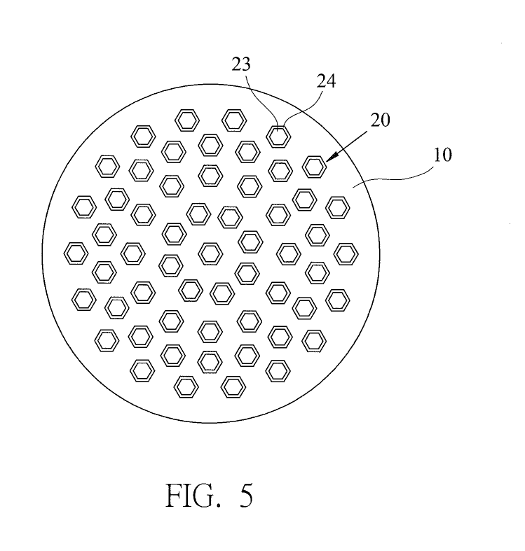

Referring to FIGS. 4 and 5, the fiber resin abutment (10) is installed with plural fiber center shafts (20). As for the optical fiber of the quartz optical fiber center shaft and the glass fiber optics center shaft, which is composed of a first layer (23) and a second layer (24), in which the first layer (23) is fiber core layer, the second layer (24) is fiber cladding layer, and the fiber cladding layer is coated and fixed at outside of the fiber core layer. Each of the above layers is composed of plural fiber center shafts.

the cross-section of the fiber center shaft is round shape.

the cross-section of the fiber center shaft is hexagonal shape.

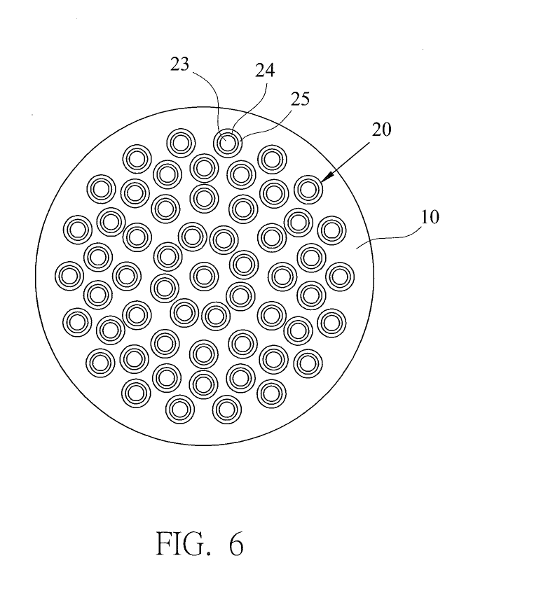

Referring to FIG. 6, the fiber resin abutment (10) is installed with plural fiber center shafts (20). The fiber center shaft (20) adopts the design of multi-fiber. For one embodiment as shown in the figure, there are three layers, including the first layer (23), the second layer (24) and a third layer (25), in which the impact force by the multi-layer fiber is several times stronger than that borne by the single layer. Each of the above layers is composed of plural fiber center shafts.

What is claimed is:

1. A fiber abutment material and structure of dental implant, including:
A fiber resin abutment equipped with a peripheral junction, and
plural fiber center shafts installed within the fiber resin abutment, in which every fiber center shaft through and fixed in the fiber resin abutment has a bottom combined end and a top free end, the bottom combined end placed at the peripheral junction of the fiber resin abutment, and the top free end placed at the position of adhesive on the peripheral surface of a bonded dental crown of the fiber resin abutment, thus the fiber resin abutment with grind ability is easily modified on-site for the dentist, is equipped with considerable fibers with tensile strength intensity higher than that of titanium or zirconia (ceramic) abutment, because of the fiber structure elasticity similar to natural tooth to be shock absorbed, to prevent the bone from hurting and decrease the damage to the base.

2. The fiber abutment material and structure of dental implant as claimed in claim 1, in which the fiber center shaft is glass fiber center shaft.

3. The fiber abutment material and structure of dental implant as claimed in claim 1, in which the fiber center shaft is quartz optical fiber center shaft.

4. The fiber abutment material and structure of dental implant as claimed in claim 1, in which the fiber center shaft is carbon fiber center shaft.

5. The fiber abutment material and structure of dental implant as claimed in claim 1, in which the fiber center shaft is glass optical fiber center shaft.

6. The fiber abutment material and structure of dental implant as claimed in claim 1, in which the fiber center shaft includes a single fiber layer, a dual fiber layer or a multiple fiber layer.

7. The fiber abutment material and structure of dental implant as claimed in claim 6, in which the dual fiber layer of the optical fiber includes a fiber core layer and a fiber cladding layer, and the fiber cladding layer is coated and fixed at outside of the fiber core layer.

8. The fiber abutment material and structure of dental implant as claimed in claim 6, in which the cross-section of the fiber center shaft is round shape.

9. The fiber abutment material and structure of dental implant as claimed in claim 6, in which the cross-section of the fiber center shaft is hexagonal shape.

10. The fiber abutment material and structure of dental implant as claimed in claim 6, in which each of the single fiber layer, the dual fiber layer or the multiple fiber layers is composed of plural fiber center shafts.
